(19) United States
(12) Patent Application Publication
(10) Pub. No.: US 2025/0158459 A1
(43) Pub. Date: May 15, 2025

(54) ELECTRIC MOTOR, IN PARTICULAR A RADIATOR FAN MOTOR

(71) Applicant: Brose Fahrzeugteile SE & Co. Kommanditgesellschaft, Würzburg, Würzburg (DE)

(72) Inventors: Christian WAGENBRENNER, Würzburg (DE); Milos GVOZDEN, Belgrade (RS); Vladimir BOZICKOVIC, Pancevo (RS)

(21) Appl. No.: 19/021,606

(22) Filed: Jan. 15, 2025

Related U.S. Application Data
(63) Continuation of application No. PCT/EP2023/069522, filed on Jul. 13, 2023.

(30) Foreign Application Priority Data
Jul. 15, 2022 (DE) 10 2022 207 247.2

(51) Int. Cl. H02K 1/18; H02K 3/34; H02K 5/10

(52) U.S. Cl. CPC H02K 1/187; H02K 3/34; H02K 5/10

(57) ABSTRACT

An electric motor contains a motor carrier with an electronics compartment for accommodating motor electronics, a stator secured to the motor carrier and has a stator winding, and a rotor circulating the stator. The stator has a stator main body with an annular main body part forming a receiving or mounting space and has radially outwardly directed stator teeth. A coil or winding insulating device is arranged on the stator main body on the side of the stator facing the motor carrier. Contact pins are arranged in the receiving or mounting space which are contacting the stator winding via connection contacts and are guided into the electronics compartment via sealing elements in through-openings of the motor carrier. The coil or winding insulating device has a number of radially inwardly directed lugs which project into the receiving or mounting space and are penetrated by a respective contact pin.

### CROSS-REFERENCE TO RELATED APPLICATION

This application is a continuation, under 35 U.S.C. § 120, of copending International Patent Application PCT/EP2023/069522, filed Jul. 13, 2023, which designated the United States; this application also claims the priority, under 35 U.S.C. § 119, of German Patent Application DE 10 2022 207 247.2, filed Jul. 15, 2022; the prior applications are herewith incorporated by reference in their entirety.

### FIELD AND BACKGROUND OF THE INVENTION

The invention relates to an electric motor, in particular a brushless external rotor motor, preferably a radiator fan motor of a motor vehicle.

An electric motor of this type usually contains a rotor that is rotatably mounted in relation to a fixed stator. In a brushless electric motor, the stator is equipped with a stator or rotating field winding, which, by applying thereto an alternating current, generates a rotating magnetic field. The rotor is usually fitted with permanent magnets, which generate a rotor magnetic field that interacts with rotating field of the stator.

In a brushless electric motor, the alternating current intended to supply the stator winding is usually generated by a converter (inverter). In smaller electric motors, this converter and the associated control electronics are often housed in an electronics compartment that is integrated in the electric motor or its motor housing. The control electronics (motor electronics) must be protected from moisture, which is why such electric motors, for example those used as radiator fan motors in motor vehicles, place comparatively high demands on the tightness of the electronics compartment. In addition, the stator winding should be reliably electrically insulated from the stator main body, which is often constructed as a laminated core formed of stacked laminations.

A brushless electric motor known from European patent EP 2 852 035 B1, corresponding to U.S. Pat. Nos. 10,734,859 and 10,734,860, and configured as an internal rotor (motor), in particular a radiator fan motor, contains a rotor mounted rotatably relative to a stator and a motor carrier which contains an electronics compartment sealed or closable with an electronics compartment lid for accommodating converter electronics. To insulate the stator winding, the stator with its radially inwardly directed stator teeth is overmolded with a plastics sheath, onto which caulking studs are molded, which engage through fixing openings provided on the motor carrier and are hot caulked and deformed, for example, in the course of joining with the motor carrier manufactured as an (aluminum) cast part.

The sealing concept of the known electric motor contains sealing elements that allow the winding or connection ends of the stator-side rotating field winding formed from coils, which serve as phase connections, to pass through the electronics compartment in a sealed manner. Sealing elements made of a two-component plastic are provided for this purpose and contain a hard and a comparatively soft sealing component as a one-piece component. In the assembled state, the sealing elements with their comparatively soft sealing component sit in through-openings that are made in the motor carrier in the region of the electronics compartment base. The comparatively hard support components of the sealing elements protrude from the support side of the motor carrier facing the stator and are seated axially above the stator-side plastics sheath in receiving pockets located therein. For reliable sealing of the winding ends at their exit points from the soft sealing component, sealing sleeves are molded onto these, which enclose the respective winding end in a sealing manner.

### SUMMARY OF THE INVENTION

The invention therefore addresses the problem of specifying an electric motor in external rotor design that is particularly suitable as a radiator fan motor. In particular, a coil insulation for the stator winding of the external rotor motor should be suitable as an additional functionality for the mechanical prestressing of sealing elements for phase contacts accommodated in the motor carrier.

This problem is solved in accordance with the invention by the features of the independent claim. Advantageous variants, embodiments and developments are the subject of the dependent claims.

With the foregoing and other objects in view there is provided, in accordance with the invention, an electric motor. The electric motor contains a motor carrier having an electronics compartment for accommodating motor electronics, the motor carrier further has through-openings. A stator is fastened to the motor carrier and has a stator winding, a stator main body with an annular main body part and radially outwardly directed stator teeth. Axially oriented contact pins and sealing elements are provided. A coil or winding insulation is disposed on a side of the stator facing the motor carrier or on the side of the stator facing the motor carrier and on a side of the stator facing away from the motor carrier on the stator main body thereof. The annular main body part of the stator main body forms a receiving or mounting space. In the receiving or mounting space, the axially oriented contact pins are disposed and make contact with the stator winding via connecting contacts and are guided into the electronics compartment via the sealing elements disposed in the through-openings of the motor carrier. The coil or winding insulation disposed on the side of the stator facing the motor carrier on the stator main body thereof has a number of radially inwardly directed lugs corresponding to a number of the axially oriented contact pins. The radially inwardly directed lugs project into the receiving or mounting space and are penetrated by the axially oriented contact pins. A rotor circulates around the stator about a rotation axis.

The brushless electric motor in external rotor design provided and set up in particular for a radiator fan motor of a motor vehicle has a plate-like or plate-shaped motor carrier (a motor carrier plate) with an electronics compartment for accommodating electronics (inverter electronics) and a stator with a stator winding (rotating field winding) and a rotor circulating around it. Suitably, the rotor has a pot-shaped rotor housing with permanent magnets arranged on the inside of the ring or housing wall. The rotor is mounted so as to be rotatable about a motor or rotation axis, which is preferably a rigid rotation axis, for example a rigid pivot bolt, fixed in the motor carrier, for example cast or molded into it.

The stator of the electric motor, which is embodied as an external rotor motor, is arranged on the support side of the motor carrier opposite the electronics compartment. The stator has a stator main body, which is preferably configured as a laminated core formed of stacked stator plates or laminations. The stator or its stator main body has a preferably annular main body portion and stator teeth arranged on the outside of the ring and directed radially outwards, on which coils of the stator winding are arranged. In the embodiment of the stator main body formed of laminations, these are substantially formed from a laminated ring with star-shaped tooth laminations molded on the outer circumference.

The annular main body part of the stator main body forms a receiving or mounting space in which axially oriented contact pins that make contact or can be contacted with the stator winding via connecting contacts are arranged. These are guided into the electronics compartment via sealing elements, wherein the sealing elements are inserted into through-openings in the motor carrier. The contact pins suitably form the phase connections that are routed to the motor electronics and serve to energize the stator winding. It is expedient to provide three such contact pins for a three-phase stator winding. Advantageously, the contact pins extend over the entire axial length or height of the housing or mounting space, which is formed in particular inside the stator main body and is enclosed by its main body part.

Coil or winding insulation is arranged on the stator main body on the side of the stator facing the motor carrier or on the side facing the motor carrier and on the side of the stator facing away from the motor carrier. The coil or winding insulation arranged on the side of the stator facing the motor carrier on the stator main body is also referred to below as the lower coil or winding insulation. The coil or winding insulation arranged on the side of the stator facing away from the motor carrier on the stator main body is also referred to below as the upper coil or winding insulation.

The (lower) coil or winding insulation arranged on the side of the stator facing the motor carrier on the stator main body has a number of radially inwardly directed lugs corresponding to the number of contact pins, which project into the receiving or mounting space and are penetrated by the respective contact pin. The stator is particularly conveniently fastened to the motor carrier by means of fastening elements, wherein the lugs of the (lower) coil or winding insulation rest against the sealing elements through which the contact pins pass, preferably by generating a prestress on the sealing elements.

Suitably, the respective lug, which is preferably molded onto the (lower) coil or winding insulation, has an axially raised insulating pin which is on the lug side facing away from the motor carrier and through which the respective contact pin passes. For this purpose, the lug or the insulating pin has a corresponding through-opening. In other words, the insulating pin, which is preferably molded onto the respective lug, is hollow-cylindrical.

In an advantageous embodiment, the respective lug, which is preferably molded onto the (lower) coil or winding insulation, has a hollow-cylindrical molded part on the lug side of the (lower) coil or winding insulation facing the motor carrier, which rests against the associated sealing element and is penetrated by the respective contact pin. Suitably, only the annular edge of the molded part is in contact with the sealing element.

As a result or in the course of fastening the stator or its stator main body to the carrier plate, the hollow-cylindrical molded part of the (lower) coil or winding insulation is pressed against the associated sealing element, so that the latter is (mechanically) pretensioned in a particularly advantageous manner without additional components. This achieves a high level of tightness in the region of the carrier-side feedthroughs of the contact pins guided into the electronics compartment without the need to provide additional components or structural elements.

An expedient development provides that the stator main body on the annular main body part has radial lugs aligned with the through-openings of the motor carrier with a through-opening for the associated contact pin. In the assembled state with the stator attached to the motor carrier, the insulating pin of the respective lug of the (lower) coil or winding insulation is seated in the through-opening of the associated radial lug of the stator main body, in particular with a form fit. In this state, the respective contact pin passes through the radial lug on the main body side and the preferably hollow-cylindrical insulating pin seated therein as well as the preferably provided hollow-cylindrical molded part of the associated lug of the (lower) coil or winding insulation. The hollow-cylindrical insulating pin and the hollow-cylindrical molded part, which is provided on the side of the lug opposite the insulating pin and is preferably molded onto it in the same way as the insulating pin, are oriented axially in such a way that their through-openings for the respective contact pin are aligned with each other.

According to a suitable embodiment, the (lower) coil or winding insulation arranged on the side of the stator facing the motor carrier on its stator main body has a (central) ring body and tooth caps for the stator teeth that are molded onto it on the circumferential side and are directed radially outwards in a star shape, wherein the lugs are molded onto the ring body on the inner circumferential side. Conveniently, the respective tooth cap has a top cap portion extending in the plane of the ring body and side cap portions molded thereon, in particular radially extending and axially oriented side cap portions. In other words, the side cap portions are oriented in the radial direction and extend at least partially or in portions in the axial direction along the side surfaces of the stator teeth. The side cap portions preferably only partially cover the side surfaces of the stator teeth in the axial direction, for example over approximately half of their axial extent. The remaining region of the stator teeth, for example the other half of the axial extent of the side surfaces of the stator teeth, is covered by the upper coil or winding insulation preferably provided.

A further advantageous embodiment is that the through-openings of the motor carrier provided to accommodate the sealing elements for the contact pins have a conical or cone-shaped opening portion that tapers towards the electronics compartment. Additionally or alternatively, the respective sealing element has a number of radial ribs on the outer circumference. The respective sealing element can also be conical or frustoconical in shape. In addition, it may be provided that a cylindrical opening portion adjoins the conical or tapered opening portion in the respective through-opening of the motor carrier.

Other features which are considered as characteristic for the invention are set forth in the appended claims.

Although the invention is illustrated and described herein as embodied in an electric motor, in particular a radiator fan motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, exploded, perspective view of a brushless electric motor in external rotor design, with a rotor and with a stator having a stator winding (rotating field winding) and with a motor carrier with an electronics compartment for motor electronics (converter electronics) that can be closed by means of an electronics compartment lid;

FIG. 2 is a sectional view of the electric motor according to FIG. 1;

FIG. 3 is a perspective view of a (lower) coil insulation;

FIG. 4 is a perspective bottom or rear view of the coil insulation according to FIG. 2;

FIG. 5 is a perspective view of the stator of the electric motor with upper and lower coil insulation, looking towards contact pins in their arrangement on the one hand in fork-shaped positioning or holding elements of the upper coil insulation and on the other hand in insulating pins on lugs of the lower coil insulation;

FIG. 6 is a perspective view according to FIG. 5 without the stator main body with a view of the lower coil insulation and its lugs with molded insulating pins and contact pins seated therein; and

FIG. 7 is an enlarged view showing a detail VII from FIG. 2 on a larger scale with the sealing feedthrough of one of the contact pins through the motor carrier into the electronics compartment.

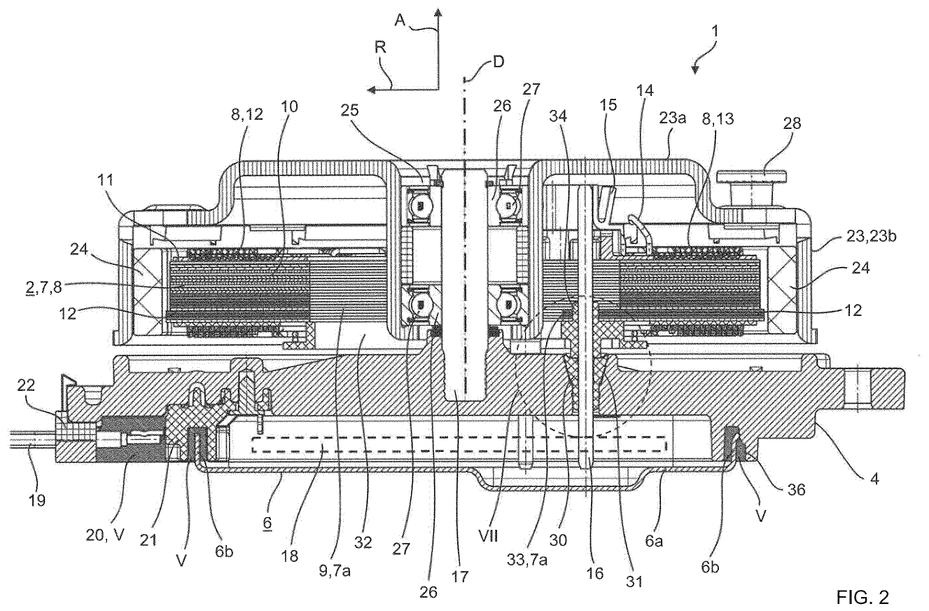

Corresponding parts and sizes are marked with the same reference signs in all figures. Specifications such as axial and radial refer to a motor axis (rotation axis) D indicated in FIG. 2 and refer to the axial and radial directions A and R, respectively, shown in FIG. 2.

### DETAILED DESCRIPTION OF THE INVENTION

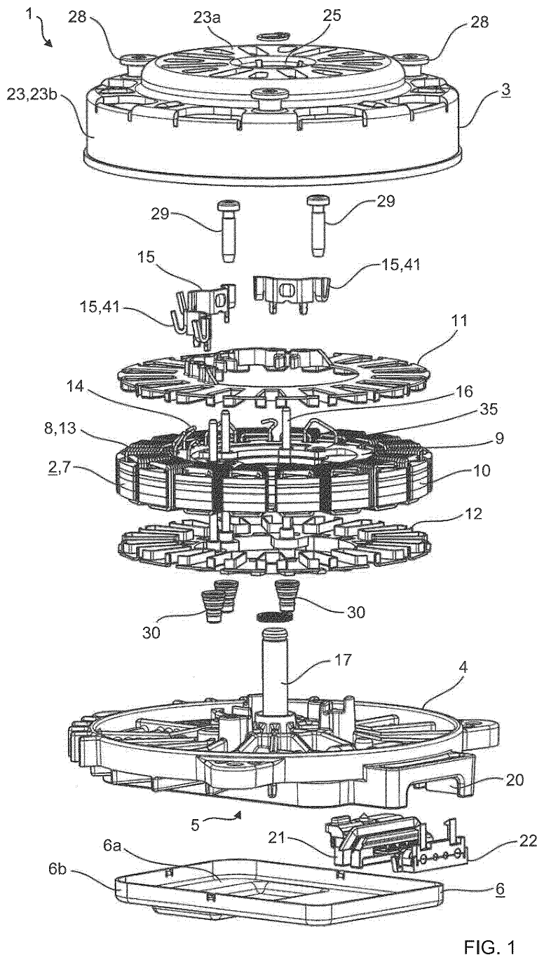

Referring now to the figures of the drawings in detail and first, particularly to FIGS. 1 and 2 thereof, there is shown an exploded view and a sectional view of an electric motor 1 configured as an external rotor, which is preferably intended and set up as a drive for a radiator fan of a motor vehicle. The electric motor 1, which is in particular three-phase (having three phases (U, V, W)), substantially has a stator 2 and a rotor 3 circulating around it as well as a (plate-like or plate-shaped) motor carrier 4, also referred to below as a support plate, with an electronics compartment 5, which can be closed with an electronics compartment lid 6. The motor carrier 4 is preferably a die-cast aluminum part. The electronics compartment lid 6, preferably made of aluminum or stainless steel, has a lid base 6a and a lid wall 6b molded thereon.

The stator 2 has a stator main body 7 and a stator or rotating field winding 8. The stator main body 7 is preferably formed from a number of laminations 7a stacked to form a laminated core. The stator 2 or its stator main body 7 has an annular main body part 9 and radially outwardly directed stator teeth 10 molded onto the outer side.

In the exemplary embodiment, a coil or winding insulation 11, 12 is provided on each of the two stator sides of the stator main body 7 or the laminated core, which are hereinafter also referred to as the upper coil insulation 11 facing away from the motor carrier 4 and the lower coil insulation 12 facing the motor carrier 4. In other words, at least one coil insulation 12 is provided, which is arranged on the side of the stator 2 facing the motor carrier 4 on its stator main body 7. The coil insulations 11, 12, which are preferably made of a plastic, for example each produced as an injection-molded part, cover the stator main body 7 and, in particular, the stator teeth 10, in each case at or on one stator side. Preferably, the coil insulations 11, 12 each partially overlap the stator main body 7 or its stator teeth 10. The stator main body 7 of the stator 2 covered by the coil insulations 11, 12 is provided with the stator winding 8, which is preferably made up of interconnected coils 13, which in turn are wound onto the individual stator teeth 10 with the coil insulations 11, 12 interposed.

In FIG. 1, the two coil insulations 11, 12 are shown separately to make them recognizable, while FIG. 2 shows the actual assembly situation of the stator main body 7 provided with the coil insulations 11, 12. The stator main body is wound with the coils 13 of the stator winding 8 with the coil insulations 11, 12 interposed. Winding loops or winding ends 14 of the stator winding 8 are electrically conductively connected to busbar-like connecting contacts 15, which connecting contacts 15 are contacted, for example (laser) welded, with contact pins 16. The contact pins 16 are or serve as phase contacts of the stator 2 or its stator winding 8.

The motor carrier 4 has, on its support side assigned to the stator 2 and the rotor 3, a rigid rotation axis in the form of an axle bolt 17, which is cast into the motor carrier 4 or arranged in a bolt receptacle of the motor carrier 4 in a rotationally fixed manner, for example cast or compressed therein. The axle bolt 17 effectively forms the rotation axis or motor axis D of the electric motor 1 or rotor 3.

On the carrier side opposite the stator 2 and the rotor 3, the electronics compartment 5 for the motor electronics 18 is provided in the motor carrier 4. The electronics compartment 5 opens at one end into a plug compartment 20, into which two plug parts 21, 22 (an inner plug part 21 and an outer plug part 22) provided for contacting with a connection cable 19 (FIG. 2) can be inserted in the exemplary embodiment. When the electric motor 1 is installed, the electronics compartment 5 is sealed, in particular in a moisture-proof manner, with the electronics compartment lid 6.

The rotor 3 has a pot-like rotor housing 23 with a housing base 23a and a housing wall (annular wall, housing wall) 23b oriented in axial direction A. Permanent magnets 24 are arranged on the inside of this wall. The rotor housing 23 has a central, preferably hollow-cylindrical housing portion deep-drawn in the housing base 23a as a bearing housing 25 for two roller or ball bearings 26, which are axially spaced in relation to the rotation axis D in the exemplary embodiment. Their unspecified outer rings are held in the deep-drawn bearing housing 25 so that they cannot rotate, and their unspecified inner rings are firmly connected to the axle bolt 17, wherein bearing balls (bearing or rolling elements) 27 are arranged between the outer and inner rings (FIG. 2).

Mounting elements 28, for example screws, correspond to the rotor housing 23 for fastening a fan wheel, not shown, of the radiator fan to the rotor 3. The other fastening elements 29, shown, for example screws or bolts, are used to fasten the stator 1 to the motor carrier 4.

Collar-like or plug-like sealing elements 30 for the contact pins 16 can also be seen in order to seal them off from the motor carrier 4. For this purpose, the motor carrier 4 has corresponding through-openings 31, in which the sealing elements 30, through which the contact pins 16 pass, fit in a sealing manner. The contact pins 16 protrude into the electronics compartment 5 in order to be contacted there with the motor or inverter electronics 18. In the exemplary embodiment, a three-phase stator winding 8 is provided, so that correspondingly three contact pins 16 connected via the connection contacts 15 as contact elements to the coils 13 of the stator or rotating field winding 8 are provided as phase connections for the stator or rotating field winding 8 and are routed to the motor electronics 18 and (electrically) contacted there.

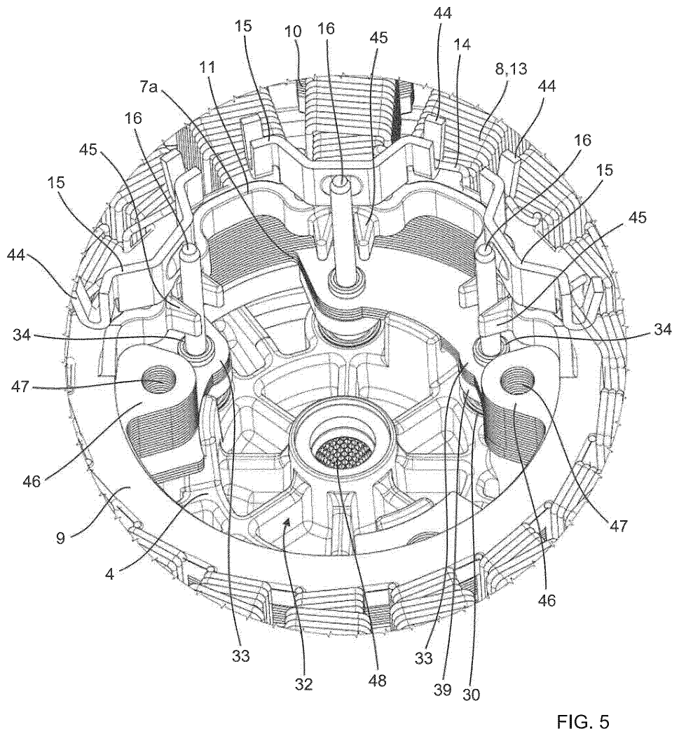

As can be seen in FIG. 2, the annular main body part 9 of the stator main body 7 forms a receiving or mounting space 32, in which the axle bolt 17 oriented in axial direction A is located as the rotation axis D for the rotor 3. In addition, the contact pins 16, which serve as phase connections, are located in this mounting space 32. Furthermore, a radial lug 33, which serves as a feedthrough for the respective contact pin 16, projects into the mounting space 32. The radial lug is formed from only some of the laminations 7a of the stator main body 7 (FIG. 5). An insulating dome or pin 34 projects, preferably form-fittingly, into the radial lug 33 or its through-opening, through which the respective contact pin 16 passes. The, in particular hollow-cylindrical, insulating dome or insulating pin 34 is part of the coil insulation 12 shown at the bottom in FIGS. 1 and 2 and is therefore preferably molded onto it.

With reference to FIG. 1, at least one further radial lug 35 is also formed by the stator main body 7 of the stator 2 or by its lamination stack and projects into the receiving space 32. The radial lug 35 has a through-opening for the respective fastening element 29 or the fastening bolt, which is described in greater detail in FIG. 5, and is used with this for mounting the stator 2 on the motor carrier 4, in particular for screw fastening.

The motor carrier 4 has a receiving groove 36 in which the electronics compartment lid 6 sits with its surrounding lid wall 6b. The receiving groove 36 is provided or filled with a potting compound V, so that a reliable seal of the electronics compartment 5 is created. A region of the inner connector part 21, in which the lid wall 6b is seated with a corresponding wall portion, and the plug compartment 20 are also provided or filled with the sealing or potting compound V.

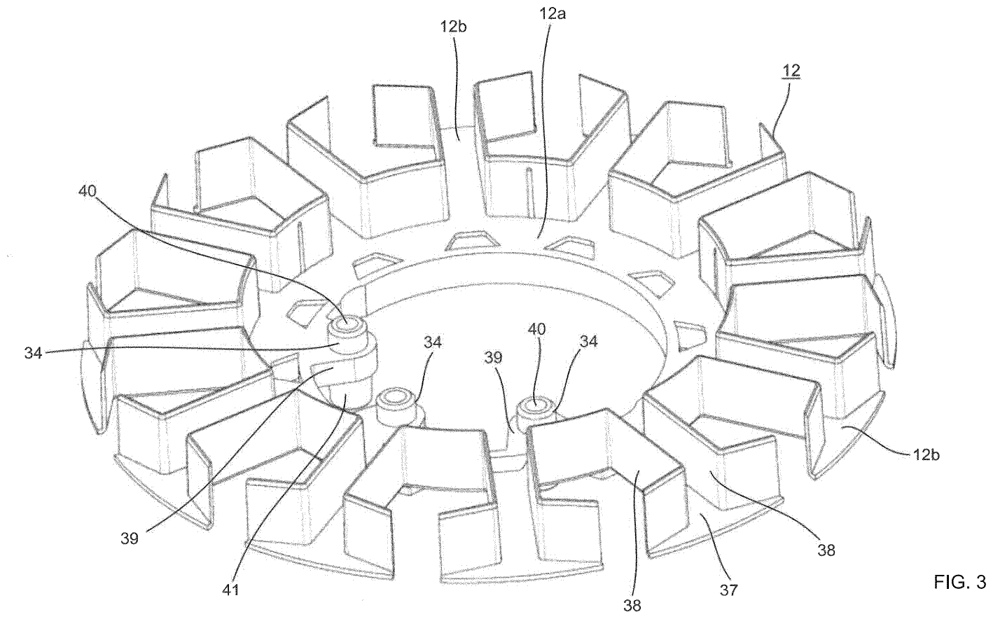

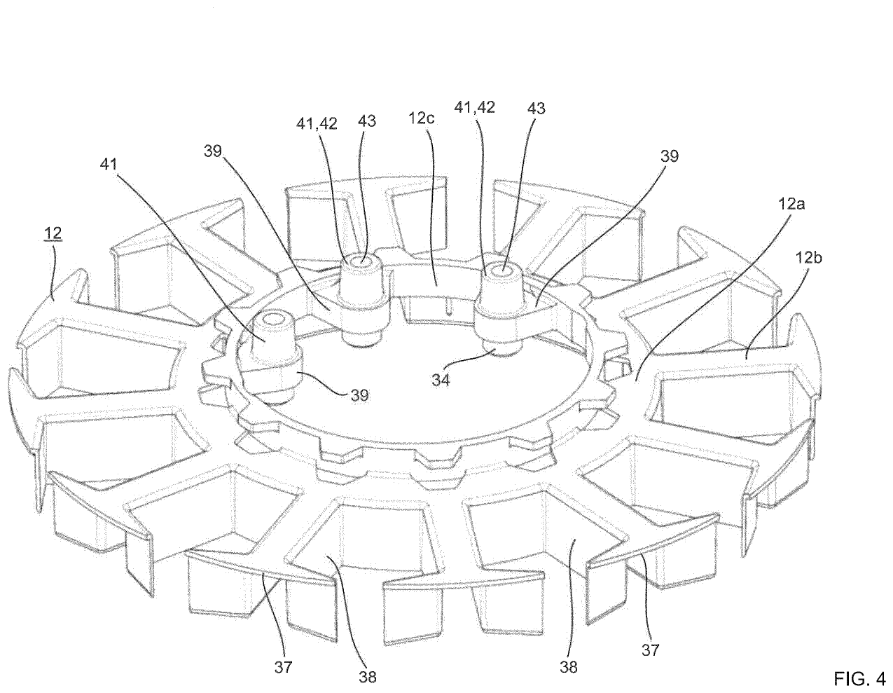

FIGS. 3 and 4 show in different perspective views, in particular in a plan view or in a bottom or rear view, the lower coil or winding insulation 12 arranged on the side of the stator 2 facing the motor carrier 4 on the stator main body 7. The insulation has a ring body 12a and tooth caps 12b molded onto the (outer) circumference thereof and directed radially outwards (in the radial direction R, in a star shape). These cover the stator teeth 10 on the stator side facing the motor carrier 4 and at least partially cover their tooth sides or side surfaces extending in axial direction A. The tooth caps 12b of the lower coil or winding insulation 12 have a top cap portion 37 extending in the plane of the ring body 12a and side cap portions 38 molded thereon, which extend radially and are oriented axially or are oriented in the radial direction R and extend in the axial direction A along the side surfaces of the stator teeth 10.

The (lower) coil or winding insulation 12 arranged on the side of the stator 2 facing the motor carrier 4 on its stator main body 7 has a number of radially inwardly directed lugs 39 corresponding to the number of contact pins 16. These protrude into the receiving or mounting space 32 of the stator 2 or its stator main body 7 and are penetrated by the respective contact pin 16. The respective lug 39 has the axially raised, hollow-cylindrical insulating pin 34 on the side of the lug 39 facing away from the motor carrier 4 (lug side), which is penetrated by the respective contact pin 16. For this purpose, the lug 39 or the insulating pin 34 molded onto it has a corresponding through-opening 40.

The respective lug 39, which is preferably molded onto the (lower) coil or winding insulation 12, has a hollow-cylindrical molded part 41 on the lug side of the (lower) coil or winding insulation 12 facing the motor carrier 4. This has an annular molded-part edge 42 for contact with the associated sealing element 30 and a through-opening 43 for the contact pin 16. The lugs 39 are molded onto the inside or inner circumference of an annular edge 12c of the ring body 12a of the (lower) coil or winding insulation 12.

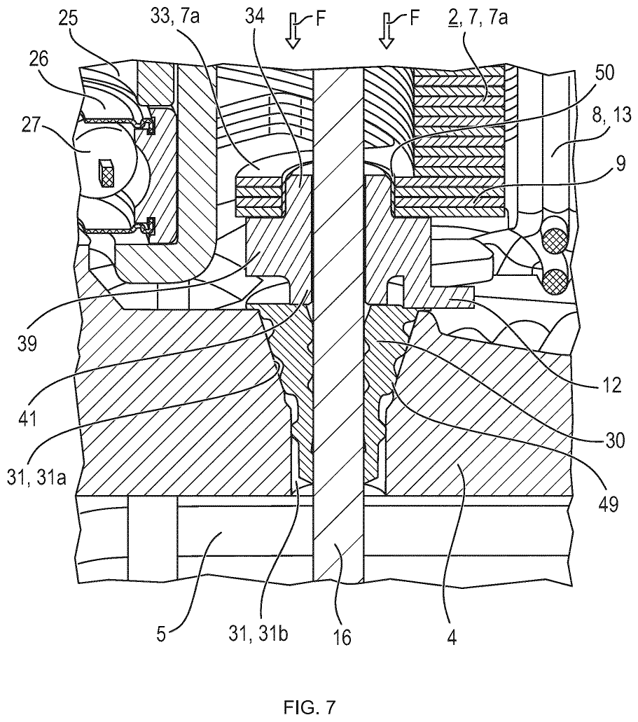

In the assembly state shown in FIGS. 2 and 7, in which the stator 2 is fastened to the motor carrier 4 by means of the fastening elements 29 and the lugs 39 of the (lower) coil or winding insulation 12 are in contact with the sealing elements 30 through which the contact pins 16 pass, preferably by generating a prestress on the sealing elements 30. The molded part 41, which is molded onto the respective lug 39 of the (lower) coil or winding insulation 12 and is axially oriented and penetrated by the respective contact pin 16, preferably rests against the associated sealing element 30 only with its annular molded-part edge 42.

FIG. 5 shows a detail of the stator 2 of the electric motor 1 with its stator main body 7 with the annular main body part 9 and the stator teeth 10 molded on the outside circumference and directed outwards in the radial direction R as well as with the coils 13 of the stator winding 8 arranged thereon with the upper and lower coil insulation 11, 12 interposed. The connection contacts 15, three in the example, and the (phase) contact pins 16 contacted with them are visible. The stator main body 7 is formed from the laminations 7a stacked to form a laminated core. The connection contacts 15 have, preferably flexible, contact lugs (bending lugs) 44, in or on which the winding loops or winding ends 14 of the coils 13 or the stator winding 8 are contacted, for example by means of laser welding and/or clamp contacting.

The upper coil insulation 11 has functional elements in the form of fork-shaped retaining or positioning elements 45 oriented in the radial direction R and projecting into the receiving or mounting space 32 of the stator 2. These serve to hold and/or position the contact pins 16 in their intended or correct target position at or relative to the connection contacts 15, in order to be contacted with these at the corresponding contact position, for example by means of (laser) welding contacting. The connecting contacts 15 are also held on the coil insulation 11, in particular by means of plug-in fastening.

FIG. 5 shows the radial lugs 33 for the associated contact pin 16 aligned with the through-openings 31 of the motor carrier 4 on the annular main body part 9 of the stator main body 7. In the assembled state with the stator 2 attached to the motor carrier, the insulating pin 34 of the respective lug 39 of the (lower) coil or winding insulation 12 is seated in the through-opening of the associated radial lug 33 of the stator main body 7, in particular with a form fit. In this state, the respective contact pin 16 passes through the radial lug 33 on the main body side and the preferably hollow-cylindrical insulating pin 34 seated therein as well as the preferably provided hollow-cylindrical molded part 41 of the associated lug 39 of the (lower) coil or winding insulation 12. The hollow-cylindrical insulating pin 34 and the hollow-cylindrical molded part 41, which is provided on the side of the lug 39 opposite the insulating pin 34 and is preferably molded onto the latter in the same way as the insulating pin 34, are oriented axially in such a way that their through-openings 40, 43 for the respective contact pin 16 are aligned with one another.

The three (phase) contact pins 16 in contact with the connection contacts 15 can be seen when looking into the mounting space 32. Shown are fastening or radial lugs 46 formed by the stator main body 7 or by the laminations 7a of the laminated core or laminated core stack with through-openings 47 for the fastening elements 29 for holding the stator 2 on the motor carrier (on the motor carrier plate) 4. In addition, a bolt receptacle 48 in the motor carrier 4 for the axle bolt 17 is shown.

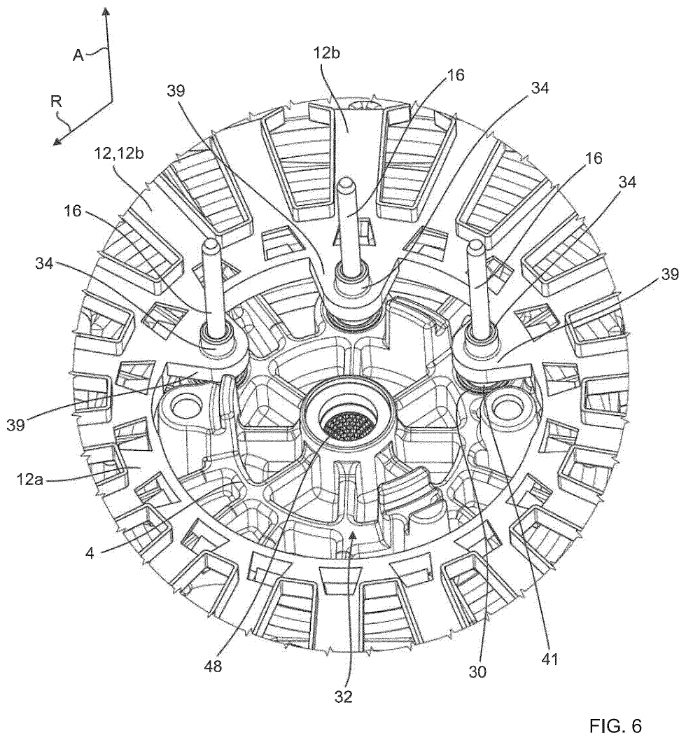

FIG. 6 shows a view of the lower coil insulation 12 with its lugs 39 projecting into the mounting space 32 and oriented in the radial direction R. The insulating pins 34, which are oriented in the axial direction A and thus axially raised, are molded onto these lugs and are penetrated by the respective contact pin 16. The lower coil insulation 12 is formed from the ring body or inner ring 12a and the tooth caps 12b, which are molded onto it on the outer circumference and extend outwards in a star shape in the radial direction R to cover the stator teeth 10, as well as the lugs 39. The insulating pins 34 molded thereon with the contact pins 16 passing through them protrude axially on the (lug) side of the lugs 39 facing away from the motor carrier 4, while the molded parts 41 molded on the opposite side of the lugs 39 rest against the sealing elements 30.

FIG. 7 shows an enlarged detail from FIG. 2 in the region of one of the sealing elements 30 for the phase contact pin 16 inserted through it and guided into the electronics compartment 5. The through-openings 31 of the motor carrier 4 provided to accommodate the sealing elements 30 for the contact pins 16 have a conical or tapered (frustoconical) opening portion 31a, which tapers towards the electronics compartment 5. The conical opening portion 31a merges into a (hollow-)cylindrical opening portion 31b of the through-opening 31 of the motor carrier 4, opening into the electronics compartment 5.

The respective sealing element 30 has a number of preferably circumferential, in particular axially spaced, radial ribs 49 on the outer circumference. The respective sealing element 30 is preferably conical or frustoconical in shape. In particular due to the conical shape or the frustoconical design of the carrier-side through-opening 31 or the sealing element 30 and preferably by means of its radial ribs 49, a reliable seal in the manner of a labyrinth seal is achieved for the contact pin 16.

The radial lug 33 formed by the stator main body 7 or its laminations 7a has the through-opening 50, in which the insulating pin 34 molded on the lug 39 of the lower coil insulation 12 sits form-fittingly. In the assembly state shown, the lugs 39 of the (lower) coil or winding insulation 12 rest on the one hand against the radial lugs 33 arranged on the annular main body part 9 of the stator main body 7. On the other hand, the lugs 39 of the (lower) coil or winding insulation 12 are in contact with the respective sealing elements 30 via the hollow-cylindrical molded parts 41. In this way, a pressure or pressing force F generated as a result of the attachment of the stator 2 to the motor carrier 4 acts on the respective sealing element 30, so that it is specifically mechanically pretensioned. This achieves a high level of tightness in the region of the carrier-side feedthroughs 31 of the contact pins 16 guided into the electronics compartment 5 without the need to provide additional components or structural elements.

In summary, the invention relates to an electric motor 1 containing a motor carrier 4 and a stator 2 attached thereto as well as a rotor 3 circulating around it. A coil or winding insulation 12 is provided at least on the side of the stator 2 facing the motor carrier 4. Contact pins 16, which make contact with the stator winding 8 of the stator 2 via connecting contacts 15 and are guided via sealing elements 30 in through-openings 31 of the motor carrier 4 into an electronics compartment 2 on the support side, are arranged in a receiving or mounting space 32 of the stator 2. The coil or winding insulation 12 has a number of radially inwardly directed lugs 39 corresponding to the number of contact pins 16, which lugs 39 project into the receiving or mounting space 32 and are penetrated by the respective contact pin 16.

The claimed invention is not limited to the embodiments described above. Rather, other variants of the invention may also be derived therefrom by a person skilled in the art within the scope of the disclosed claims without departing from the subject manner of the claimed invention. In particular, all the individual features described in conjunction with the various exemplary embodiments can also be combined in other ways within the scope of the disclosed claims without departing from the subject matter of the claimed invention.

The following is a summary list of reference numerals and the corresponding structure used in the above description of the invention:
1 electric motor
2 stator
3 rotor
4 motor carrier/carrier plate
5 electronics compartment
6 electronics compartment lid
6a lid base
6b lid wall
7 stator main body
7a lamination
8 stator/rotating field winding
9 main body part
10 stator tooth
11 (upper) coil insulation
12 (lower) coil insulation
12a ring body/inner ring
12b tooth cap
12c ring edge
13 coil
14 winding loop/winding end
15 connection contact
16 contact pin
17 axle bolt
18 motor/converter electronics
19 connection cable
20 plug compartment
21 (inner) plug part
22 (outer) plug part
23 rotor housing
23a housing base
23b housing/ring wall
24 permanent magnet
25 housing portion/bearing housing
26 roller/ball bearing
27 bearing ball
28 mounting element
29 fastening element
30 sealing element
31 through-opening
31a conical/cone-shaped opening portion
31b cylindrical opening portion
32 receiving/mounting space
33 radial lug
34 insulating dome/pin
35 radial lug
36 receiving groove
37 top cap portion
38 side cap portions
39 lug
40 through-opening
41 molded part
42 molded-part edge
43 through-opening
44 contact/bending lugs
45 holding/positioning element
46 fastening/radial lug
47 through-opening
48 bolt receptacle
49 radial rib
50 through-opening
A axial direction
D motor/rotation axis
F (pressure/pressing) force
R radial direction
V potting/sealing compound

1. An electric motor, comprising:
a motor carrier having an electronics compartment for accommodating motor electronics, said motor carrier further having through-openings formed therein;
a stator fastened to said motor carrier and having a stator winding, a stator main body with an annular main body part and radially outwardly directed stator teeth;
axially oriented contact pins;
sealing elements;
a coil or winding insulation disposed on a side of said stator facing said motor carrier or on said side of said stator facing said motor carrier and on a side of said stator facing away from said motor carrier on said stator main body thereof;
said annular main body part of said stator main body forming a receiving or mounting space, in said receiving or mounting space said axially oriented contact pins are disposed and make contact with said stator winding via connecting contacts and are guided into said electronics compartment via said sealing elements disposed in said through-openings of said motor carrier;
said coil or winding insulation disposed on said side of said stator facing said motor carrier on said stator main body thereof has a number of radially inwardly directed lugs corresponding to a number of said axially oriented contact pins, said radially inwardly directed lugs project into said receiving or mounting space and are penetrated by said axially oriented contact pins; and
a rotor circulating around said stator about a rotation axis.

2. The electric motor according to claim 1,
further comprising fastening elements, said stator is fastened to said motor carrier by means of said fastening elements; and
wherein said radially inwardly directed lugs of said coil or winding insulation bear against said sealing elements through which said axially oriented contact pins pass.

3. The electric motor according to claim 1, wherein each of said radially inwardly directed lugs of said coil or winding insulation has a hollow-cylindrical shaped part which bears against an associated one of said sealing element and through which a respective one of said axially oriented contact pin passes.

4. The electric motor according to claim 1, wherein each of said radially inwardly directed lugs of said coil or winding insulation has an axially raised insulating pin, and through said axially raised insulating pin a respective one of said axially oriented contact pins passes.

5. The electric motor according to claim 4, wherein:
said stator main body on said annular main body part has radial lugs aligned with said through-openings of said motor carrier and said radial lugs each having a through-opening formed therein for associated ones of said axially oriented contact pins; and
said axially raised insulating pin of a respective one of said radially inwardly directed lugs of said coil or winding insulation is seated in said through-opening of an associated one of said radial lugs of said stator main body.

6. The electric motor according to claim 1, wherein said coil or winding insulation disposed on said side of said stator facing said motor carrier on said stator main body thereof has a ring body and tooth caps for said stator teeth formed thereon on a circumference, wherein said radially inwardly directed lugs are formed on an inner circumference of said ring body.

7. The electric motor according to claim 6, wherein said tooth caps have a top cap portion extending in a plane of said ring body and side cap portions formed extending from said top cap portion.

8. The electric motor according to claim 1, wherein said stator main body is formed as a laminated core from a plurality of stacked laminations.

9. The electric motor according to claim 1, wherein:
said through-openings of said motor carrier provided for receiving said sealing elements for said axially oriented contact pins have a conical or conical opening portion tapering towards said electronics compartment; and/or
each of said sealing elements has a plurality of radial ribs on an outer circumference of said sealing elements; and/or
each of said sealing elements is conical or frustoconical in shape.

10. The electric motor according to claim 9, wherein said through-openings of said motor carrier have a cylindrical opening portion adjoining said conical or conical opening portion.

11. The electric motor according to claim 1, wherein the electric motor is configured to be a radiator fan motor of a motor vehicle.

12. The electric motor according to claim 2, wherein said radially inwardly directed lugs of said coil or winding insulation bear against said sealing elements through which said axially oriented contact pins pass with a prestress being generated on said sealing elements.

13. The electric motor according to claim 7, wherein said side cap portions extend radially and are oriented axially.
